(19) United States
(12) Patent Application Publication
(10) Pub. No.: US 2013/0084842 A1
(43) Pub. Date: Apr. 4, 2013

(54) Mobility Management of User Equipment

(71) Applicants: Pasi Petteri Laitinen, Oulunsalo (FI); Antti-Eemeli Suronen, Oulu (FI); Antti Olavi Kangas, Oulunsalo (FI)

(72) Inventors: Pasi Petteri Laitinen, Oulunsalo (FI); Antti-Eemeli Suronen, Oulu (FI); Antti Olavi Kangas, Oulunsalo (FI)

(73) Assignee: Renesas Mobile Corporation

(21) Appl. No.: 13/249,553

(22) Filed: Sep. 30, 2011

(51) Int. Cl. H04W 36/00; H04W 76/00

(52) U.S. Cl. 455/418

(57) ABSTRACT

There is provided a method, including obtaining, by a user equipment, information related to the speed of the user equipment in at least one first radio access technology; and applying the obtained information in a second radio access technology upon changing to the second radio access technology, wherein the second radio access technology is different from the present first radio access technology.

### FIELD

The invention relates generally to mobile communication networks. More particularly, the invention relates to mobility management of user equipment upon changing to a different radio access technology (RAT).

### BACKGROUND

User equipment (UE) may locate in the coverage areas of two different RATs or move to a coverage area of another RAT. When the UE determines, for example, that the currently serving RAT is not providing as good radio coverage as the second RAT would, the UE may perform a cell reselection to the second RAT or the network may trigger a handover of the UE to the second RAT. However, the second RAT and the UE may not be able co-operate optimally at the start due to various reasons.

### BRIEF DESCRIPTION OF THE INVENTION

Embodiments of the invention seek to improve mobility management in the network upon RAT change.

According to an aspect of the invention, there is provided a method as specified in claim 1.

According to an aspect of the invention, there is provided an apparatus as specified in claim 9.

According to an aspect of the invention, there is provided a computer program product as specified in claim 17.

According to an aspect of the invention, there is provided an apparatus comprising means configured to perform any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIG. 1 presents a communication network where some of the embodiments may be carried out;

FIG. 2 shows an inter-RAT handover scenario according to an embodiment;

FIGS. 3 to 5 show methods according to some embodiments;

FIG. 6 illustrates an apparatus according to an embodiment.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Radio communication networks, such as the Long Term Evolution (LTE) or the LTE-Advanced (LTE-A) of the 3^{rd} Generation Partnership Project (3GPP), are typically composed of at least one base station (also called a base transceiver station, a radio network controller, a Node B, or an evolved Node B, for example), at least one user equipment (UE) (also called a user terminal, terminal device or a mobile station, for example) and optional network elements that provide the interconnection towards the core network. The base station connects the UEs via the so-called radio interface to the network. The base station may provide radio coverage to a cell, control radio resource allocation, perform data and control signaling, etc. The cell may be a macrocell, a microcell, or any other type of cell where radio coverage is present.

In general, a base station may be configured to provide communication services according to at least one of the following radio access technologies (RATs): Worldwide Interoperability for Microwave Access (Wi-MAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), LTE, and/or LTE-A. The present embodiments are not, however, limited to these protocols. The base station may be node B (NB) or an evolved node B (eNB) as in the LTE or in the LTE-A, a radio network controller (RNC) as in the UMTS, a base station controller (BSC) as in the GSM/GERAN, or any other apparatus capable of controlling radio communication and managing radio resources within the cell.

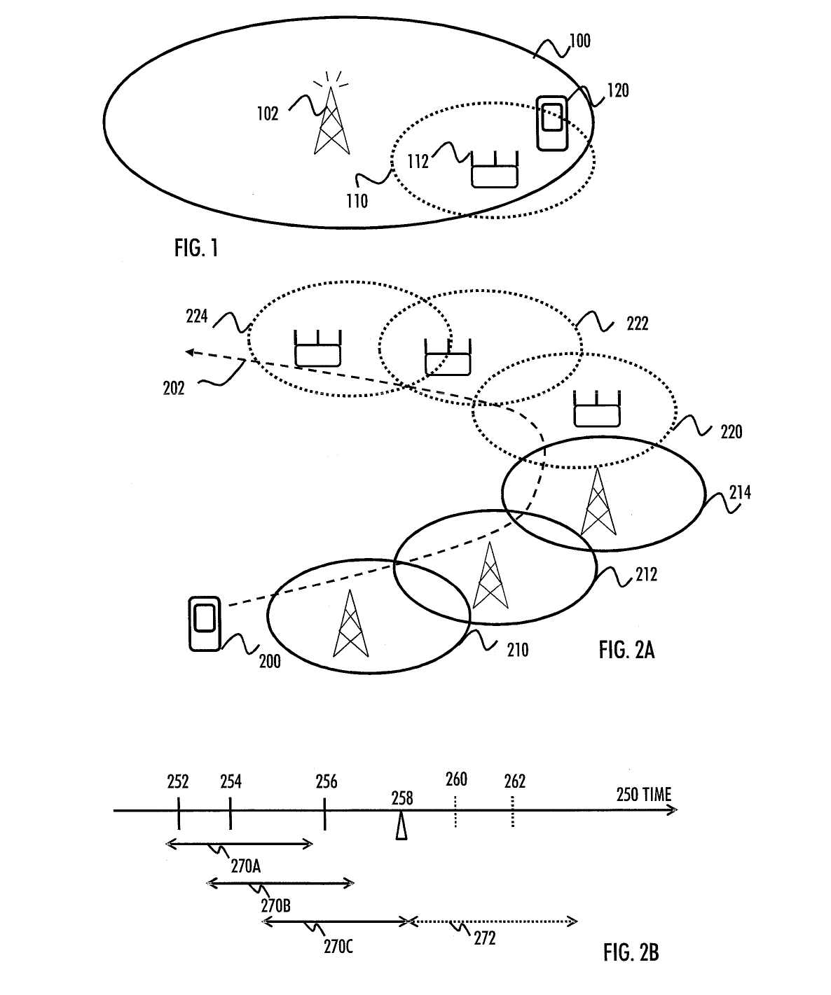

Such a scenario where the user equipment is located in coverage areas of several RATs may exist, as is shown in FIG. 1. Let us assume that a base station 102 provides GSM radio access for the coverage area 100 and another base station 112, such as an evolved node B (eNB), provides LTE or LTE-A radio access for the coverage area 110, shown with a dashed circle. As seen from the Figure, the UE 120 is located in a place where both RATs are accessible. Assuming that the UE 120 is in a connected mode (such as in an RRC_connected mode in the LTE), the serving base station may, at least partly on the basis of measurement reports from the UE, decide to perform a handover to the other RAT. This is called an inter-RAT handover.

The reason for the handover may be that the radio coverage from the other RAT is better than from the currently serving RAT, or that the UE 120 needs services that are provided by the other RAT and not the currently serving RAT. On the other hand, when the UE 120 is in an idle mode (such as in an RRC_idle mode in the LTE) or when the UE 120 starts up, the UE 120 may decide to make a cell reselection. The target cell in the reselection may belong to a RAT that is different from the earlier RAT. Thus, the UE 120 may end up being served by a RAT which is different from the currently serving RAT as opposed to intra-RAT cell changes.

For example, in the UMTS and in the LTE, the UE may keep track of the speed of the UE. The speed may be determined, for example, by detecting the number of cell changes in a certain time window (such as t-evaluation), the speed may be obtained from the network, or it may be obtained from the global position in system (GPS), for example. The speed of the UE may then determine a mobility state of the UE, i.e. depending on the detected number of cell changes in the defined time window, for example, the UE changes its mobility state. The mobility state may be represented with one of a plurality of values, such as normal, medium and high, for example. Alternatively, the mobility state may be represented by a numerical value, for example. The mobility state may affect how the UE behaves. In an embodiment, once the UE determines that criteria for another mobility state is reached, certain parameters (depending on whether the UE is in the RRC_IDLE or in the RRC_CONNECTED) are scaled accordingly. For example, the UE may (if so commanded by the network), after detecting a high mobility state (for example, the UE is moving in high speed), adjust the measurement reporting—related parameters to trigger measurement report to the network with shorter triggering times as well as scale the associated signal quality thresholds (as commanded by the network), for example. This in turn may trigger the network to command a handover more rapidly than if the UE was in normal or medium mobility state. Naturally, there may be more parameters to adjust than the handover triggering, as known by a skilled person.

The UE may obtain the criteria for changing into different mobility states from the RAT as part of initial broadcast information when the UE moves to or becomes operational in a new RAT. Alternatively or in addition to, the UE may be precoded with such information. In yet another embodiment, the information may be unicasted to the UE, i.e. by using point-to-point messages, where message(s) is/are dedicated/addressed to one UE only, or multi casted to the UE, i.e. by transmitting, by the network, a message to a group of UEs. There may also be further instructions that the UE may follow when setting its mobility state. For example, when the mobility state is changed on the basis of how many cell changes are made, it may be that the UE may not count consecutive reselections or handovers between same two cells into mobility state detection criteria if same cell is selected just after one other selection.

However, what may happen is that the UE has fulfilled the criteria for certain mobility state (e.g. in a fast train) and therefore has set the mobility state into the high state, for example. Then the UE may change to another RAT (either by being commanded by the network via a handover or a cell change order, or by itself via a cell reselection, as per the standards relevant for each particular radio access technology). Even though the UE may have previously set its state into the high mobility state (or, may have performed an amount of cell reselections or handovers that would qualify the UE to enter the medium or the high mobility state according to the mobility state-related parameters valid in the target cell/radio access technology), the UE starts in the new RAT with normal state even if still moving fast. The same may happen when the UE temporarily visits the new RAT and then returns to the original RAT, i.e., the UE still starts off with normal mobility mode in the original RAT, even if the mobile is still moving fast. However, it may also be that the original RAT keeps the number of cell changes stored in a memory and when the UE returns to the original RAT, the RAT continues calculating the number of cell changes from the stored number onwards. This may depend on the duration of a time window within which the cell changes need to take place. In other words, the RAT may see all the cell changes in the current RAT within the time window even if the UE has visited another RAT in between of the previous cell change and the current point in time. For instance, if the UE has carried out a cell change in the LTE two minutes ago, has after that visited the UMTS RAT and has then entered again to the LTE cell where the time-window is determined as three minutes, the cell change that happened two minutes ago in the LTE may be taken into account. However, it may happen that it may take some time for the UE to set its mobility state into the high mode in the new RAT because the UE is not initially in the correct mobility state. This may cause problems in the selected RAT as the UE is moving in high speed with parameters that are not scaled correctly.

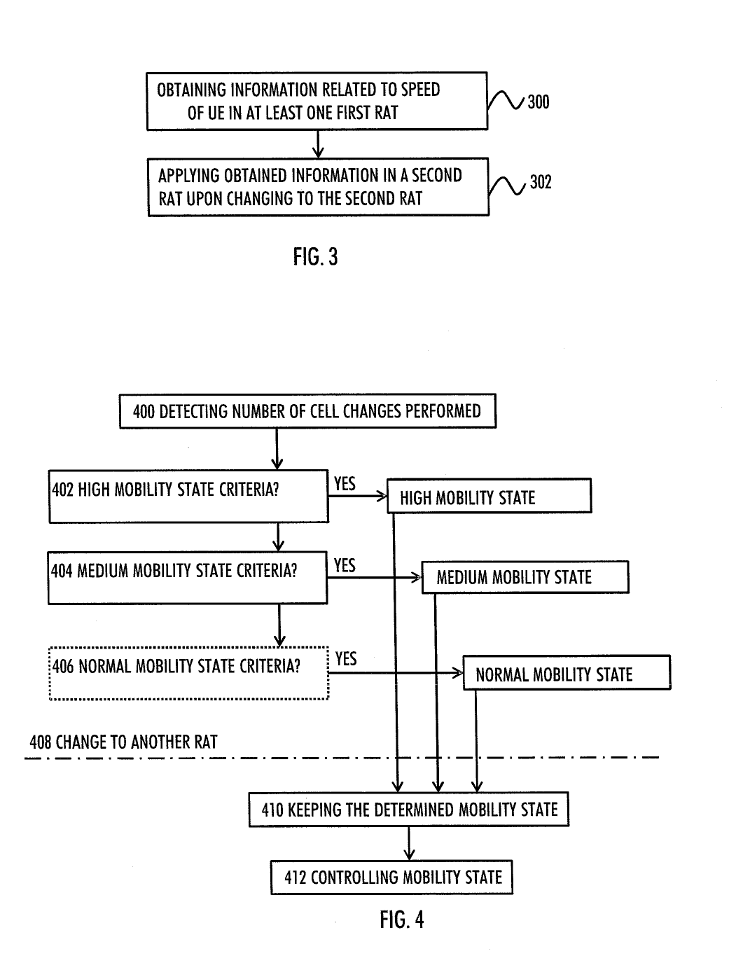

At least partly for this reason, a more optimal solution is needed for inter-RAT scenarios with respect to mobility management. Therefore it is proposed that, as shown in FIG. 3, the UE may in step 300 obtain information related to a speed of the UE in at least one first radio access technology and, in step 302, apply the obtained information in a second radio access technology upon changing to the second radio access technology, wherein the second radio access technology is different from the present first radio access technology. As said before, the changing to the second RAT may take place through a handover or through a cell reselection, for example. The proposed solution may allow the UE, upon RAT-change, to inherit speed related information with respect to the previous/present first RAT in order to determine a mobility state in the target, second RAT.

FIG. 2A shows UE moving on a trajectory 202 across several cells 210 to 224, some 210 to 214 of which are under the UMTS, for example, and some 220 and 224 are under the LTE, for example. Again, the LTE cells 220 to 224 are shown with dashed circles. In FIG. 2, the UMTS is considered as the first RAT and the LTE is considered as the second RAT. FIG. 2B then shows a time line 250 and cell changes 252 to 260 that take place when the UE 200 enters to the cell 210 and moves in its trajectory 202. Let us assume for simplicity reasons that the UE 200 is in the connected mode and hence that the cell changes 252 to 260 are handovers, for example. Then the handover from a cell to the cell 210 is depicted in FIG. 2B with a reference numeral 252, the handover from the cell 210 to the cell 212 is depicted in FIG. 2B with a reference numeral 254, etc. The inter-RAT handover from the UMTS cell 214 to the LTE cell 220 is depicted with a reference numeral 258 in FIG. 2B.

As said, the UE may obtain information related to its speed in a plurality of means, such as GPS positioning system, from the network, etc. For the sake of simplicity, let us assume that the UE 200 obtains this information by detecting the number of cell changes within a time window. FIG. 2B shows time windows with reference numerals 270 (270A to 270C) and 272. The duration of the time windows 270 and 272 may be RAT-specific, i.e. each RAT may determine and broadcast its own time window duration. In addition or instead, the duration of the time windows 270 and 272 may be cell-specific, i.e. each cell may have its own duration of the time window, although not shown in FIG. 2B, The duration may be called a t-evaluation duration, for example. In FIG. 2B, the time window 272 of the LTE RAT is depicted to be longer than the time window 270 of the UMTS, for example. However, it may be longer or shorter depending on the RAT requirements. The window length may also vary within a RAT depending on deployment location. For example, the length of the window in rural or mountain areas may vary from the corresponding window in urban areas.

The mobility state may be determined so that the UE determines the number of cell changes (in this example handovers) within the time window 270A, for example. In general the network may determine that when x cell changes has been performed during the time window 270, the UE changes into the medium mobility state and when y cell changes has been performed during the time window 270, the UE changes into the high mobility state, for example. Also, the UE keeps or changes into the normal mobility state, when the number of cell changes is less than or equal to x, for example. Now it may be seen from FIG. 2B that the UE 200 has performed two handovers 252 and 254 within the RAT- and/or cell-specific time window 270A. Let us assume that two cell changes is the threshold for changing into the high mobility state. As this threshold is met, the UE 200 changes into the high mobility state when the second handover 254 is made. It may be understood that UE 200 is on-board of a fast running car or a train, for example. The RAT- and/or cell-specific time window 270 may in an embodiment be a sliding time window. This is shown with reference numerals 270B and 270C, which depict the time window 270A slid in time. In FIG. 2B, the UE 200 is shown to perform handovers with such a density that the high mobility state is maintained. For example, the handovers 254 and 256 are made within the slid time window 270B.

As said, the cell 220 is served by a LTE base station (eNB) whereas the cell 214 is served by the UMTS base station. Thus, the handover from the cell 214 to the cell 220 is an inter-RAT handover. When the UE is in the cell 214, the mobility state is already set as the high mobility state because the handovers have been made with such a high density, as said above. However, in prior art, when the UE changes to the new RAT (in this case to the LTE) by performing the handover 258, the UE would not take any information related to the speed of the UE in the first RAT (for example the previous UMTS RAT) into use in the new LTE RAT. This would directly cause the UE 200 to start from the normal mobility state as the initial mobility state of the UE 200 in the second RAT, i.e. in the cell 220 even though the UE 200 might still be running fast. Assuming that two handovers within the RAT-specific time window 272 need to be made in order to change into the high mobility state also in the LTE, it would take till the point where handover 262 is made before the UE 200 would change its LTE mobility state into the high mobility state. Even worse, in some cases it might take till the end of time window 272 before the UE 200 would change its state, depending on the system configuration.

Now according to the proposed solution, the UE advantageously takes the obtained mobility related information into use when entering a new RAT. In an embodiment this takes place substantially immediately in point when the handover 258 is made. For example, the UE 200 may use the mobility related information which has been obtained in the past (in one or more RATs) to determine the mobility state in the next RAT. In an embodiment, the mobility related information comprises the number of cell reselections, cell change orders and handovers that have taken place in the past (in the one or more RATs). This may provide significant advantage to the UE 200 as it immediately scales the parameters that are scalable depending on the set mobility state correctly.

It should also be noted, that the at least one first RAT comprises in an embodiment the present RAT the UE 200 is communicating with before changing to the second RAT. In the embodiment of FIG. 2, the at least one first RAT comprises the UMTS RAT with cells 210 to 214 and the second RAT is the LTE RAT comprising the cells 220 to 224. However, a skilled person may appreciate that the at least one first RAT may in an embodiment comprise also at least one previous RAT the UE has been communicating with. In other words, the UE 200 in FIG. 2 may have been served by a GSM RAT (previous first RAT) before entering the UMTS RAT (=present first RAT). In this case, the UE 200 may have observed speed related information in the GSM RAT as well and use that information when entering the second RAT (=LTE RAT in FIG. 2). For example, such scenario may have taken place although not shown in FIG. 2, that the criteria for high mobility state is four handovers in a certain time window and the UE has experienced two handovers in the GSM network and two more in the UMTS RAT before entering the LTE RAT. Then the UE may decide to enter the high mobility state because altogether four cell changes were made within the time window, even though the four cell changes were spread over two different RATs (GSM and UMTS). In this manner the at least one previous first RAT is taken into account in addition to the present first RAT.

In an embodiment, the UE may detect the number of cell changes within at least a known recording period in at least one RAT. For this it is assumed that the at least one RAT, a first RAT and/or a second RAT, employs a RAT-specific sliding time window, such as the time window 270 or 272, during which the cell changes within the specific RAT are to be detected. In this embodiment, the known recording period may be at least as long as the maximum defined length of the at least one RAT-specific sliding time window. That is, at least as long as the maximum defined value for the t-evaluation parameter among the at least one RAT. Thus, the UE may not store the cell changes with time stamps for perpetuity, but at least for a known recording period. This may allow the UE to save the memory resources, for example.

The UE may be precoded with knowledge of the defined RAT-specific sliding time window maximum lengths. For example, an UE with capabilities to operate in the UMTS and in the LTE may be precoded with LTE and UMTS RAT specifications which may determine the maximum defined valued for the t-evaluation in both of the RATs. Then the UE may select the longer of the values as the known recording period. For example, when the maximum defined value for the time window duration in a RAT R1 is 10 minutes, in RAT R2 it is 15 minutes and in RAT R3 it is 5 minutes, then the UE may keep the records of cell changes for up to 15 minutes, regardless in which RAT it is operating. This may enable the UE to always correctly assess the UE mobility state in any given RAT.

In an embodiment, the information related to the speed of the user equipment comprises a mobility state of the user in the present first radio access technology. This was shown in FIG. 2, where the UE applied the mobility state of the UE with respect to the UMTS RAT in the second, LTE RAT. A method according to the embodiment is shown in FIG. 4, wherein the UE may in step 400 determine the number of cell changes within a RAT-specific time window in the at least one first RAT, wherein the cell changes comprise at least one of a handover, a cell change order and a cell reselection. The RAT-specific time window may be the RAT-specific time window 270, for example, which may be specific for the present first RAT. As said, the UE may obtain the criteria for switching into different mobility states via network broadcasting, via uni- or multicasting, or via a precoded data, for example. By knowing the mobility state criteria, the UE may, in step 402, check if the criteria for the high mobility state are detected during the time window. For example, this may denote checking if the number of cell changes exceeds a predetermined criterion. If the answer is positive, the high mobility state is entered. However, if the answer is negative, it is checked in step 404 whether the criteria for the medium mobility state are fulfilled or not. If the answer is positive, the medium mobility state is entered. However, if the answer is negative, a normal mobility mode is entered, possibly via step 406, which may in an embodiment be omitted. In this way the UE determines the mobility state of the UE in the present first RAT at least partly on the basis of the amount of cell changes and criteria set by the present first RAT.

In FIG. 4 it is assumed that the change to a new RAT takes place in step 408. This may take place by means of a handover or a cell reselection. In this embodiment, the UE keeps the set mobility state in the second RAT in step 410, i.e., the determined mobility state is applied as an initial mobility state of the user equipment in the second radio access technology. Therefore, the UE substantially immediately applies the correct mobility state as the UE has inherited the actual mobility state. This option may thus allow for a more optimal adaptation to the requirements of the new RAT with respect to the mobility of the UE. This option may also allow for a small overhead as the only extra information to carry to the target, second RAT is the indication of the mobility state determined in the original, first RAT. This may be done with, for example, two bits. Thus, the embodiment may allow for simple implementation. After the initial mobility state is set in the second RAT, the UE may keep on controlling the mobility state in the second RAT in step 412. This may take place in the same way as depicted in steps 400 to 406, for example.

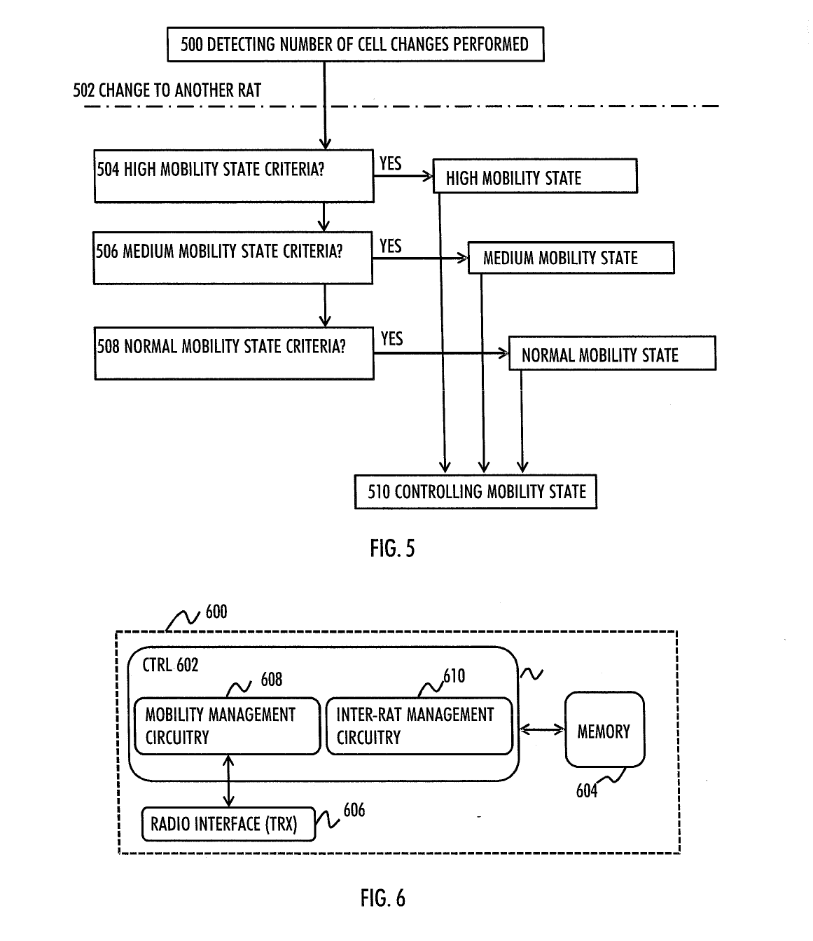

In another embodiment, the information related to the speed of the user equipment comprises the number of cell changes performed in the at least one first radio access technology, wherein the cell changes comprise at least one of a handover, a cell change order and a cell reselection. This is shown in FIG. 5, where UE in step 500 may determine the number of cell changes within the known recording period in the at least one first RAT. The cell change may take place in a handover (connected mode, such as the RRC_connected mode) or in a cell reselection (idle mode such as the RRC-idle mode), for example. The UE may, for example, store in a memory the number of cell changes experienced and their occurrence in time, i.e. the time stamps. The UE may follow further criteria as well, such as that the UE may not count consecutive reselections or handovers between same two cells into mobility state detection criteria if same cell is selected just after one other selection. However, as said, the cell changes may take place among a plurality of first RATs (for example, GSM and UMTS) or within one first RAT (such as the UMTS RAT of FIG. 2). The cell change is to be understood to cover also the inter-RAT cell changes.

In FIG. 5 it is assumed that the inter-RAT change takes place in step 502. Even though the UE may have had determined its mobility state in the first RAT (i.e. prior to the inter-RAT change 502), the UE does not apply that mobility state directly as the initial mobility state in the second RAT. Instead, the UE knowing the criteria for the mobility states in the second RAT (for example, by receiving a broadcast from the network right after being handed over to the second RAT), may compare the information related to the detected number of cell changes in the first RAT with the received criteria. The UE may have stored the number of cell changes and possibly also the time instant for each of the cell changes or a time window during which the cell changes have occurred in the memory of the UE. Then the UE may in steps 504, 506 and 508 determine the mobility state of the user equipment in the second RAT least partly on the basis of the detected amount of cell changes in the at least one first RAT and criteria set by the second RAT.

It should be noted that the criteria for different mobility states may be different between different RATs. Therefore, the mobility state of the first RAT may not correspond to the same mobility state in the second RAT. Thus, a kind of mapping table between the criteria of different RATs may be of use. The UE may, for example, determine that two cell changes in the first RAT (which may indicate high mobility state in the first RAT) may lead to medium mobility state in the second RAT. By having the information related to the cell changes and to the timing of the cell changes stored in the UE or the time duration during which the cell changes have taken place, the UE may use that information in the second RAT together with the criteria of the second RAT. In an embodiment, the UE may inherit the amount or number of cell changes in a maximum amount of evaluation time defined in the specification instead of the actual mobility state. As a result, the UE may apply the mobility state determined in the second RAT as an initial mobility state of the UE in the second RAT. From then on the UE may control the mobility state in the second RAT in step 510, which controlling may take place in a similar manner as shown in FIG. 4 with steps 402 to 406, for example. This embodiment may allow for an accurate initial mobility state determination in the second RAT. This option may also allow the UE to have the correct mobility state in the second RAT right from the beginning as opposed to the prior art solutions, for example.

An embodiment, as shown in FIG. 6, provides an apparatus 600 comprising at least one processor 602 and at least one memory 604 including a computer program code, wherein the at least one memory 604 and the computer program code are configured, with the at least one processor 602, to cause the apparatus 600 to carry out at least some of the above-described processes. It should be noted that FIG. 6 shows only the elements and functional entities required for understanding the apparatus 600. Other components have been omitted for reasons of simplicity. The implementation of the elements and functional entities may vary from that shown in FIG. 6. The connections shown in FIG. 6 are logical connections, and the actual physical connections may be different. The connections can be direct or indirect and there can merely be a functional relationship between components. It is apparent to a person skilled in the art that the apparatus may also comprise other functions and structures.

The apparatus 600 may comprise the terminal device of a cellular communication system, e.g. a computer (PC), a laptop, a tabloid computer, a cellular phone, a communicator, a smart phone, a palm computer, or any other communication apparatus. In another embodiment, the apparatus is comprised in such a terminal device, e.g. the apparatus may comprise a circuitry, e.g. a chip, a processor, a micro controller, or a combination of such circuitries in the terminal device and cause the terminal device to carry out the above-described functionalities. Further, the apparatus 600 may be or comprise a module (to be attached to the UE) providing connectivity, such as a plug-in unit, an “USB dongle”, or any other kind of unit. The unit may be installed either inside the UE or attached to the UE with a connector or even wirelessly.

As said, the apparatus 600 may comprise the at least one processor 602. The at least one processor 602 may be implemented with a separate digital signal processor provided with suitable software embedded on a computer readable medium, or with a separate logic circuit, such as an application specific integrated circuit (ASIC). The at least one processor 602 may comprise an interface, such as computer port, for providing communication capabilities.

The at least one processor 602 may comprise a mobility management circuitry 608. The circuitry 608 may be responsible of setting the mobility state of the apparatus 600. The circuitry 608 may obtain information of the criteria for the mobility states, for example. The circuitry 608 may perform scaling of certain parameters depending on which mobility state is reached. The circuitry 608 may also detect the number of cell changes performed. Even though not shown, the apparatus 600 may comprise a clock which may be of use when applying a RAT- or cell-specific time window or the known recording period, for example.

The at least one processor 602 may also comprise an inter-RAT management circuitry 610 for managing the scenarios where the serving RAT changes. The circuitry 610 may perform a handover or a cell reselection to the new RAT, updating of certain parameters due to the inter-RAT change, for example.

The apparatus 600 may further comprise radio interface components 606 providing the apparatus with radio communication capabilities with the radio access network. The radio interface components 606 may comprise standard well-known components such as amplifier, filter, frequency-converter, (de)modulator, and encoder/decoder circuitries and one or more antennas.

As said, the apparatus 600 may comprise a memory 604 for storing information. The information stored may comprise for example the criteria for the mobility states, information related to the time windows in different RATs, the mobility state of the apparatus 600, the detected number of cell changes, GPS data, etc.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Thus, according to an embodiment, the apparatus comprises processing means configure to carry out embodiments of any of the FIGS. 1 to 6. In an embodiment, the at least one processor 602, the memory 604, and the computer program code form an embodiment of processing means for carrying out the embodiments of the invention. In an embodiment, the apparatus comprises processing means for obtaining, by a user equipment, information related to a speed of the user equipment in at least one first radio access technology and processing means for applying the obtained information in a second radio access technology upon changing to the second radio access technology, wherein the second radio access technology is different from the present first radio access technology.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method, comprising:
obtaining, by a user equipment, information related to the speed of the user equipment in at least one first radio access technology; and
applying the obtained information in a second radio access technology upon changing to the second radio access technology, wherein the second radio access technology is different from the present first radio access technology.

2. The method of claim 1, wherein the at least one first radio access technology comprises the present radio access technology the user equipment is communicating with before changing to the second radio access technology.

3. The method of claim 1, wherein the at least one first radio access technology comprises at least one previous radio access technologies the user equipment has been communicating with.

4. The method of claim 1, wherein the information related to the speed of the user equipment comprises the number of cell changes performed in the at least one first radio access technology, wherein the cell changes comprise at least one of a handover, a cell change order and a cell reselection.

5. The method of claim 1, wherein the information related to the speed of the user equipment comprises a mobility state of the user in the present first radio access technology.

6. The method of claim 1, further comprising:
detecting the number of cell changes within at least a known recording period in at least one radio access technology, wherein:
the at least one radio access technology employs a radio access technology-specific sliding time window during which the cell changes within the specific radio access technology are to be detected, and
the known recording period is at least as long as the maximum defined length of the at least one radio access technology-specific sliding time window.

7. The method of claim 1, further comprising:
determining the number of cell changes within at least the radio access technology-specific sliding time window in the at least one first radio access technology, wherein the cell changes comprise at least one of a handover, a cell change order and a cell reselection, and the sliding time window is specific for the present first radio access technology;
determining a mobility state of the user equipment in the present first radio access technology at least partly on the basis of the amount of cell changes and criteria set by the present first radio access technology; and
applying the determined mobility state as an initial mobility state of the user equipment in the second radio access technology.

8. The method of claim 1, further comprising:
determining the number of cell changes within at least the known recording period in the at least one first radio access technology, wherein the cell changes comprise at least one of a handover, a cell change order and a cell reselection; and
determining the mobility state of the user equipment in the second radio access technology at least partly on the basis of the detected amount of cell changes in the at least one first radio access technology and criteria set by the second radio access technology; and
applying the determined mobility state as an initial mobility state of the user equipment in the second radio access technology.

9. An apparatus, comprising:
at least one processor and at least one memory including a computer program code, wherein the at least one memory and the computer program code are configured to, with the at least one processor, cause the apparatus at least to:
obtain information related to the speed of a user equipment in at least one first radio access technology; and
apply the obtained information in a second radio access technology upon changing to the second radio access technology, wherein the second radio access technology is different from the present first radio access technology.

10. The apparatus of claim 9, wherein the at least one first radio access technology comprises the present radio access technology the user equipment is communicating with before changing to the second radio access technology.

11. The apparatus of claim 9, wherein the at least one first radio access technology comprises at least one previous radio access technologies the user equipment has been communicating with.

12. The apparatus of claim 9, wherein the information related to the speed of the user equipment comprises the number of cell changes performed in the at least one first radio access technology, wherein the cell changes comprise at least one of a handover, a cell change order and a cell reselection.

13. The apparatus of claim 9, wherein the information related to the speed of the user equipment comprises a mobility state of the user in the present first radio access technology.

14. The apparatus of claim 9, wherein the apparatus is further caused to:
detect the number of cell changes within at least a known recording period in at least one radio access technology, wherein:
the at least one radio access technology employs a radio access technology-specific sliding time window during which the cell changes within the specific radio access technology are to be detected, and
the known recording period is at least as long as the maximum defined length of the at least one radio access technology-specific sliding time window.

15. The apparatus of claim 9, wherein the apparatus is further caused to:
determine the number of cell changes within at least the radio access technology-specific sliding time window in the at least one first radio access technology, wherein the cell changes comprise at least one of a handover, a cell change order and a cell reselection, and the sliding time window is specific for the present first radio access technology;
determine a mobility state of the user equipment in the present first radio access technology at least partly on the basis of the amount of cell changes and criteria set by the present first radio access technology; and
apply the determined mobility state as an initial mobility state of the user equipment in the second radio access technology.

16. The apparatus of claim 9, wherein the apparatus is further caused to:
determine the number of cell changes within at least the known recording period in the at least one first radio access technology, wherein the cell changes comprise at least one of a handover, a cell change order and a cell reselection; and
determine the mobility state of the user equipment in the second radio access technology at least partly on the basis of the detected amount of cell changes in the at least one first radio access technology and criteria set by the second radio access technology; and
apply the determined mobility state as an initial mobility state of the user equipment in the second radio access technology.

17. A computer program product embodied on a distribution medium readable by a computer and comprising program instructions which, when loaded into an apparatus, execute the method according to claim 1.
